(19) United States
(12) Patent Application Publication
(10) Pub. No.: US 2010/0037915 A1
(43) Pub. Date: Feb. 18, 2010

(54) METHODS AND APPARATUS FOR MINIMIZING AIRBORNE DUST IN FLOOR MAINTENANCE MACHINES

(76) Inventors: Kale R. Johnson, Minneapolis, MN (US); Samuel Sangman Han, Plymouth, MN (US); Kevin J. Miller, Plymouth, MN (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/529,037

(22) PCT Filed: Feb. 28, 2008
(86) PCT No.: PCT/US08/55263

§ 371 Date: Aug. 28, 2009

Related U.S. Application Data
(60) Provisional application No. 60/892,088, filed on Feb. 28, 2007.

(51) Int. Cl. A47L 7/00; B08B 7/00

(52) U.S. Cl. 134/6; 15/320

(57) ABSTRACT

Airborne dust is controlled and minimized by spraying a fine spray mist by nozzles (50) in a direction tangential to and spaced from spaced, vertical, parallel axes of counter-rotating first and second front brooms (26) and opposite to the rotation direction and angled to the floor in front of the axes. The fluid is pumped at a rate in the order of 0.033 gallons (125 ml) per minute and at a pressure in the order of 40 psi (2.81 kg/cm) through the nozzles (50) having orifice diameters in the order of 0.015 inch (0.38 cm) and a spray angle in the order of 110° to produce droplets having a volume mean diameter in the order of less than 220 microns. The fine spray mist adheres to the airborne particulates to control settling of the airborne particles onto the floor and without build-up of moisture on the floor being swept.

### BACKGROUND

The present invention generally relates to novel methods and apparatus to contain airborne dust in the operation of a floor maintenance machine.

A common method for collecting and containing floor debris (litter, sand, dust, etc) is through the use of a sweeper machine. These machines typically have front broom(s), a main broom, a hopper, a vacuum device to control dust and a dust filter. It should be appreciated that engagement of dust by brooms and even movement of the machine causes dust to become airborne, with the front brooms generating the majority of the airborne particles. Larger, outdoor machines of this classification spray a stream of water in front of the machine to minimize airborne dust. However, spraying a stream of water can not be used in most indoor machines especially since many indoor floor surfaces can not be wetted and/or the creation of mud or similar slurry must be avoided.

Thus, a need exists to control and minimize airborne dust developed, with substantial design and the mode of operation being expanded and improved over conventional prior art systems.

### SUMMARY

The present invention solves this need and other problems in the field of floor maintenance by providing, in a most preferred form, a fine mist spray adjacent to the rotating broom to adhere to, collect and control airborne particulates generated by the rotating broom from being swept by the broom and without build-up of moisture on the surface being swept.

In most preferred aspects of the present invention, the broom rotates about an axis generally perpendicular to the surface being swept, with the fine mist spray being sprayed in a direction tangential to and spaced from the axis and opposite to the rotation direction and in the most preferred form from above the broom at an angle to the surface to intersect the surface in the operation direction in front of the axis.

In other preferred aspects of the present invention, the fine mist spray includes particle droplets having a volume mean diameter in the order of less than 220 microns and is formed by pumping fluid at a pressure of about 40 psi (2.81 kg/cm) through a nozzle having an orifice diameter in the order of 0.015 inch (0.38 cm) and no larger than 0.026 inch (0.066 cm) and at a rate in the order of 0.033 gallons (125 ml) per minute and no larger than 0.1 gallons (378 ml) per minute. In a preferred form, the nozzle has a spray angle in the order of 110°.

In the most preferred form of the present invention, first and second nozzles are located intermediate first and second counter-rotating front brooms which direct dust to a main broom also carried by the frame.

The present invention will become clearer in light of the following detailed description of an illustrative embodiment of this invention described in connection with the drawings.

### DESCRIPTION OF THE DRAWINGS

The illustrative embodiment may best be described by reference to the accompanying drawings where:

FIG. 1 shows a perspective view of a system for controlling and minimizing airborne dust according to the preferred teachings of the present invention, with a floor sweeper machine shown in phantom.

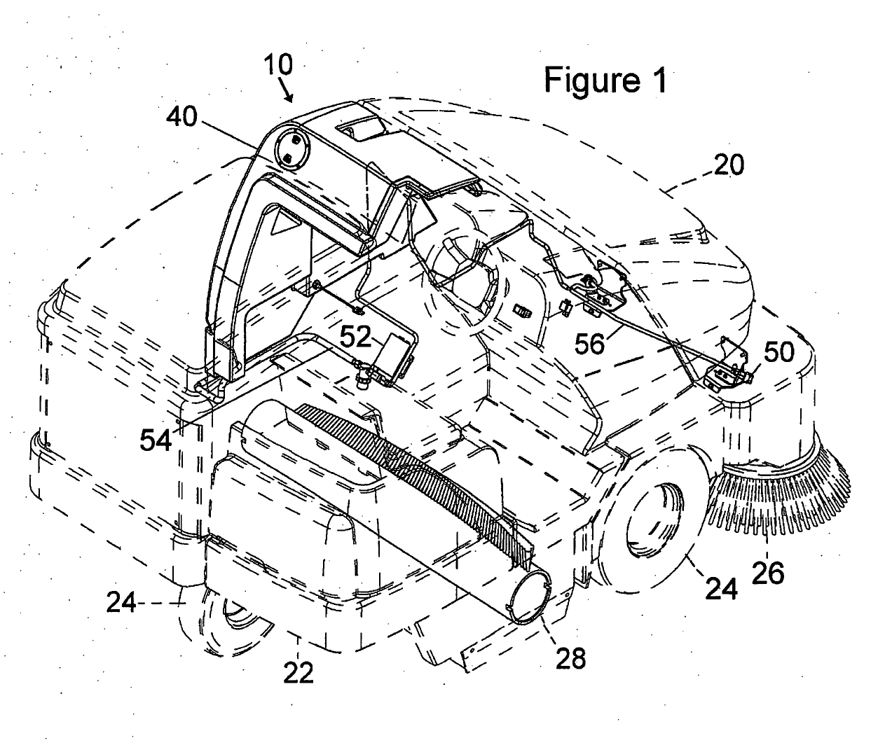

FIG. 2 shows a bottom view of the system of FIG. 1, with the floor sweeper machine shown in phantom.

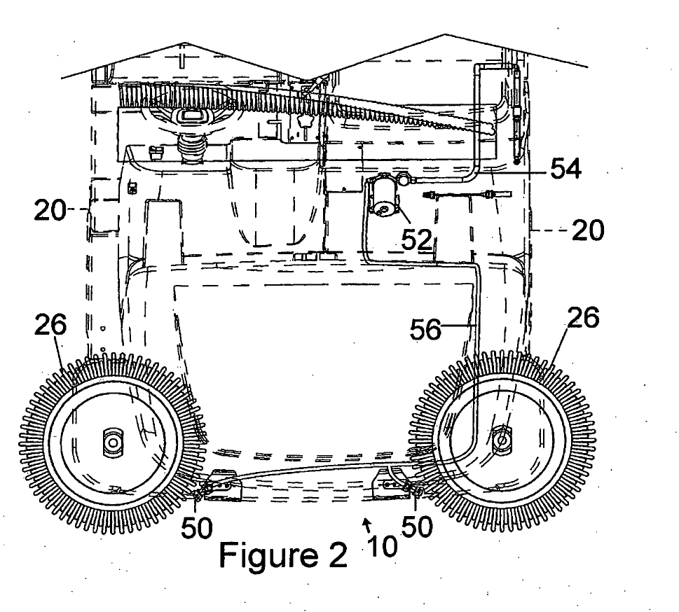

FIG. 3 shows a front view of the system of FIG. 1, with the floor sweeper machine shown in phantom.

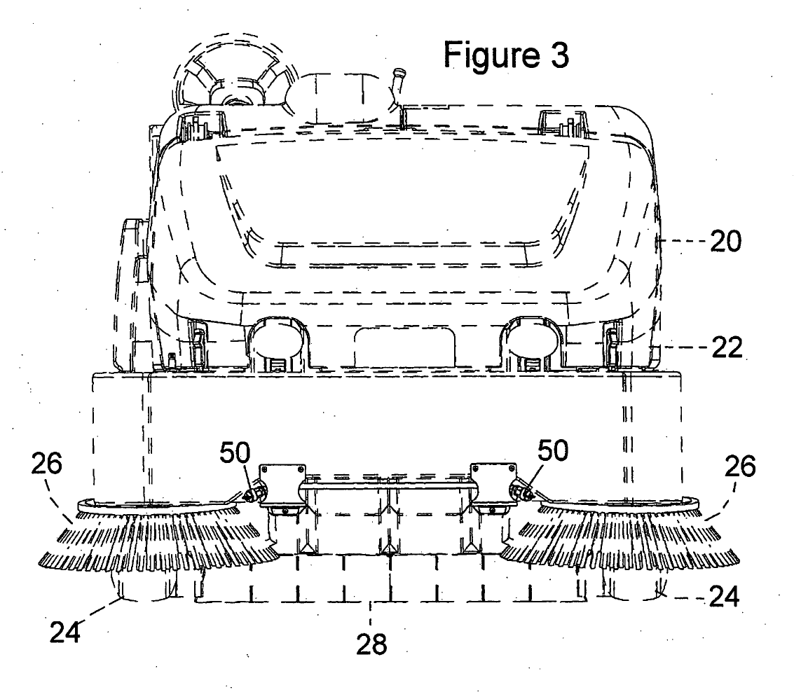

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “top”, “bottom”, “first”, “second”, “side”, “end”, “inner”, “outer”, “inside”, “outside”, “upper”, “lower”, “front”, “rear”, “back”, and similar terms are used herein, it should be understood that these terms have reference only to the structure shown in the drawings as it would appear to a person viewing the drawings and are utilized only to facilitate describing the preferred embodiment.

### DESCRIPTION OF THE PREFERRED EMBODIMENTS

A system for controlling and minimizing airborne dust developed during a floor maintenance operation is generally shown in the drawings and designated 10. In the most preferred form, system 10 is shown as utilized on a floor sweeper machine 20 which can be utilized either indoors or outdoors. Although sweeper machine 20 is shown as a self-propelled, ride on unit, it should be appreciated that system 10 according to the teachings of the present invention can be utilized in other types of sweeper machines and/or floor maintenance machines than the one shown.

Generally, machine 20 includes a frame 22 adapted to be movably supported upon the surface to be cleaned such as by wheels 24. In the preferred form, one or more of wheels 24 are driven so as to propel frame 22 upon the surface in an operation direction. Further, machine 20 includes at least one front broom 26 rotatable about a vertical axis generally perpendicular to the surface to be cleaned and to the operation direction. Rotation of front broom 26 is in a direction to bring the forward portion of front boom 26 towards the center of frame 22. Front broom 26 is located at one or both of the forward corners of frame 22. When first and second front brooms 26 are located at opposite corners, the second front broom 26 is rotatable about an axis parallel to and spaced from the axis of the first front broom 26, with the first and second brooms 26 rotating in counter directions. Machine 20 further includes a main broom 28, a hopper and a vacuum device which includes a dust filter.

System 10 generally includes a tank 40 mounted to the frame 22 for holding water or other wetting solution, with conventional sweeper machines 20 not previously including a source of water or other wetting solution. In the most preferred form shown, tank 40 also functions as a cover for frame 22 to create a pleasant outward aesthetics as well as to enclose internal components of machine 10.

System 10 further includes a nozzle 50 for each front broom 26, with nozzles 50 located intermediate first and second brooms 26 in the preferred form shown. A pump 52 is in fluid communication with tank 40 such as through a conduit 54 and provides controlled flow of fluid to nozzle 50 through a conduit 56. It should be appreciated that suitable filters, such as one inline filter positioned before pump 52 and another stainless steel filter/strainer just before nozzle 50, can be provided to prevent clogging of nozzles 50. A check valve can also be provided to prevent dripping and/or leaking through nozzles 50 when system 10 is turned off.

According to the teachings of the present invention, nozzles 50 do not spray a stream of water but rather provide a mist spray of fluid such as water, and in the most preferred form, not a heavy mist spray but a fine mist spray. In the preferred form, nozzle 50 provides particle droplet sizes small enough to remain airborne for several seconds. Such particle droplets have a volume mean diameter (VMD) in the order of less than 220 microns. Specifically, in the most preferred form, nozzle 50 has an orifice diameter in the order of 0.015 inch (0.38 cm) and no larger than 0.026 inch (0.066 cm) and provides a flow in the order of 0.033 gallons (125 ml) per minute and no larger than 0.1 gallons (378 ml) per minute. Further, with nozzles 50 of the preferred form, a controlled pump pressure of about 40 psi (2.81 kg/cm) is also defined to produce a fine spray. Furthermore, nozzles 50 of the preferred form has a spray angle in the order of 110°. It should be appreciated that other manners of providing fine mist spray can be utilized in system 10 according to the teachings of the present invention including, but not limited to, using high pressure nozzles and mechanical foggers/nozzles. Furthermore, as previously indicated, a flocculating agent or other detergent solution may be used in addition to or instead of water to produce the fine mist spray. Flocculants accelerate the rate at which dust particles clump together and drop out of the fine mist spray and are swept up by broom 26.

System 10 according to the preferred teachings of the present invention is also advantageous in the placement of the fine mist spray. Specifically, the fine spray mist is provided in a direction opposite to the rotation direction of front broom 26 at a location behind the forward extent of front broom 26 and inwardly of frame 20 from the forward extent of front broom 26. In the most preferred form, nozzle 50 is located outwardly of the inward extent of front broom 26. Further, the fine spray mist is directed in a direction tangential to and spaced from the front broom 26 according to the preferred teachings of the present invention. Furthermore, the fine spray mist originates from a position elevated above front broom 26 and in a direction extending downwardly to the floor and specifically at an angle which intersects the floor at a location corresponding to the lateral position in front of the rotation axis of front broom 26 in the operation direction. It should be appreciated that although the placement of the fine mist spray in the manner as shown and described is believed to produce synergistic results, the fine mist spray could be placed in other manners according to the teachings of the present invention.

It should also be appreciated that this fine mist spray of system 10 according to the teachings of the present invention is not limited to the front brooms 26, it also is directed and carried to the main broom 28 that generates particles. This fine mist spray collects and controls airborne particulate settling by adhering to these particles allowing them to be contained.

It should be appreciated that fine mist spray collects and controls dust without a significant and noticeable build-up of moisture on the floor surface. Maintaining a dry floor reduces potential injury for someone to slip and fall. Further, a fine mist spray also prevents the creation of mud or other wetted debris from being swept into the hopper. This aids in easier cleaning and maintenance of the hopper. This also eliminates the dust filter to become wet and ineffective. The fine mist spray also substantially reduces water consumption, allowing for a smaller onboard storage tank 40 and increasing time between re-fills. This is more economical and user friendly.

Moisture could start collecting when machine 20 is stationary. However, system 10 according to the preferred teachings of the present invention incorporates an auto start/stop function to prevent this build-up by stopping the flow to the nozzles 50 when machine 20 is stationary and when brooms 26 stop. Also, system 10 according to the preferred teachings of the present invention can include a built in low water cut-off switch and a protective mount/guard for system 10.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. (canceled)

2. Apparatus for sweeping a surface of dust comprising, in combination: a frame movably supported for movement upon the surface to be swept in an operation direction; a first front broom rotatable about an axis generally perpendicular to the surface to be swept and to the operation direction; and a first sprayer providing a mist spray which remains airborne adjacent to the first front broom, wherein the first front broom is rotated in a rotation direction about the axis, with the first sprayer providing the mist spray in a direction tangential to and spaced from the axis and opposite to the rotation direction.

3. The apparatus of claim 2 wherein the first front broom is located intermediate the first sprayer and the surface to be swept, with the first sprayer providing the mist spray at an angle to intersect the surface to be swept at a location in the operating direction in front of the axis.

4. The apparatus of claim 3 wherein the first sprayer sprays particle droplets having a volume mean diameter in an order of less than 220 microns.

5. The apparatus of claim 4 wherein the first sprayer is a nozzle.

6. The apparatus of claim 5 wherein the nozzle has an orifice diameter in the order of 0.015 inch (0.038 cm) and provides a flow in the order of 0.033 gallons (125 ml) per minute.

7. The apparatus of claim 6 further comprising, in combination: a tank carried by the frame; and a pump in fluid communication with the nozzle and the tank, with the pump pumping fluid at a pressure of about 40 psi (281 kg/cm).

8. The apparatus of claim 7 wherein the nozzle has a spray angle in the order of 110°.

9. The apparatus of claim 7 further comprising, in combination: a second front broom rotatable about an axis parallel to and spaced from the axis of the first front broom, with the first and second front brooms rotating in counter directions; and a second sprayer providing a mist spray adjacent to the second front broom, with the first and second sprayers located intermediate the first and second brooms.

10. The apparatus of claim 9 wherein the second sprayer provides the mist spray in a direction tangential to and spaced from the axis of the second front broom and opposite to the rotation direction of the second front broom.

11. (canceled)

12. Method for sweeping a surface of dust comprising:
rotating a first broom engaging the surface to be swept and moving dust relative to the surface, with rotating the first broom creating airborne particulates; and
providing a mist spray adhering to the airborne particulates while airborne to collect and control settling of the airborne particulates onto the surface for being swept by the rotating first broom and without build-up of moisture on the surface being swept, wherein rotating the first broom comprises rotating the first broom about an axis generally perpendicular to the surface being swept and in a rotation direction; and providing the mist spray comprises spraying the mist spray in a direction tangential to and spaced from the axis and opposite to the rotation direction.

13. The method of claim 12 wherein spraying the mist spray comprises spraying the mist spray from above the first broom and at an angle to the surface in front of the axis of the first broom when the axis of the first broom is being moved forwardly.

14. The method of claim 13 wherein providing the mist spray comprises providing the mist spray with particle droplets having a volume mean diameter in an order of less than 220 microns.

15. The method of claim 14 wherein spraying the mist spray comprises flowing fluid through a nozzle creating the mist spray.

16. The method of claim 15 wherein flowing the fluid comprises flowing the fluid at a rate in the order of 0.033 gallons (125 ml) per minute through the nozzle having an orifice diameter in the order of 0.015 inch (0.038 cm).

17. The method of claim 16 wherein flowing the fluid comprises flowing the fluid at a pressure of about 40 psi (281 kg/cm) through the nozzle.

18. The method of claim 17 wherein flowing the fluid comprises flowing fluid through the nozzle having a spray angle in the order of 110°.

19. The method of claim 17 further comprising:
counter rotating a second broom about an axis parallel to and spaced from the axis of the first broom; wherein providing the mist spray comprises providing the mist spray intermediate the first and second brooms, with providing the mist spray comprising spraying the mist spray in a direction tangential to and spaced from the axis and opposite to the rotation direction of the second broom.

20. The method of claim 15 wherein flowing the fluid comprises flowing the fluid including a flocculating agent accelerating clumping of the airborne particulates together for being swept by the first broom.
